(19) United States
(12) Patent Application Publication
(10) Pub. No.: US 2012/0050392 A1
(43) Pub. Date: Mar. 1, 2012

(54) USE OF COMPOSITION FOR IMPROVING INKJET PRINTING PROPERTIES AND AN INKJET RECORDING SHEET

(76) Inventors: Sami Puttonen, Helsinki (FI); Mari Ojanen, Espoo (FI); Kimmo Huhtala, Turku (FI)

(21) Appl. No.: 13/319,447

(22) PCT Filed: May 11, 2010
(86) PCT No.: PCT/FI2010/050377

§ 371 Date: Nov. 8, 2011

(30) Foreign Application Priority Data
May 11, 2009 (FI) 20095526

(51) Int. Cl. B41J 2/015; B41J 3/407

(52) U.S. Cl. 347/21; 347/106

(57) ABSTRACT

The invention relates to an inkjet recording sheet and use of a composition for improving inkjet printing properties of an inkjet recording sheet comprising wood or lignocellulosic fibre material. According to the invention the composition comprises calcium sulphate dihydrate and starch solution.

The invention relates to use of composition for improving inkjet printing properties, an inkjet recording sheet and a method according to the preambles of the enclosed independent claims.

Inkjet printing is one of the digital printing methods and it is widely used technology in printers intended for office and home use, as well as for commercial printing. In digital printing the printed document is directly produced from an electronic data file, whereby every print may be different from each other, as no printing master is required. Because the interest in digital printing is increasing also the demand for recording substrates suitable for high-speed inkjet printing machines may be expected to increase.

In inkjet printing droplets of ink are ejected from a nozzle at high speed towards a recording sheet. Inkjet printing makes specific demands on the printing substrate, which usually is a recording sheet made of paper or board. For example, printed ink colour density, ink absorption, ink drying time, Cobb60 values, water fastness and mottling are important variables that are optimised in making of inkjet recording sheets. Preferably, an inkjet recording sheet would provide a high image quality while using inexpensive raw materials.

Recording sheets, such as paper, comprising lignocellulosic fibres are usually surface sized or coated in order to meet the demands of inkjet printing. It is known to use silica-based coatings, which are expensive compared to conventional coatings used in paper industry. EP 1775141 discloses a recording sheet where a divalent metal salt, particularly calcium chloride, is applied on the substrate surface.

Calcium sulphate is used in paper industry as filler and in paper coating compositions. Calcium sulphate exists in different crystalline forms, i.e. as mineral anhydrite CaSO₄, as calcium sulphate dihydrate CaSO₄×2H₂O or as calcium sulphate hemihydrate 2 CaSO₄×H₂O.

Calcium sulphate dihydrate, which also known as gypsum, CaSO₄×2H₂O, occurs as a natural mineral or it may be formed as a by-product of chemical processes, e.g. as phosphogypsum or flue gas gypsum. It is possible to refine impure gypsum by first calcining it into calcium sulphate hemihydrate, 2 CaSO₄.×H₂O, after which it may be hydrated back by dissolving the hemihydrate in water and precipitating it to give pure gypsum.

Depending on the calcination conditions of the gypsum raw material, the calcium sulphate hemihydrate may occur in two forms: as α- and β-hemihydrate. The β-form is obtained by heat-treating gypsum raw material at atmospheric pressure while the α-form is obtained by treating gypsum raw material at a steam pressure which is higher than atmospheric pressure or by means of chemical wet calcination from salt or acid solutions at e.g. about 45° C.

The different crystalline forms of calcium sulphate are structurally different and have different properties. For example, calcium sulphate anhydrite has a rhombic crystal structure whereas calcium sulphate dihydrate posses a monoclinic crystal structure. Due to these differences the behaviour of different forms of calcium sulphate in practical applications differ from each other

GB 2 034 729 discloses a method for beating calcium sulphate dihydrate in presence of dispersing agent consisting of a polysaccharide substituted with carboxyl groups. One of the advantages mentioned is the possibility to use waste gypsum from the manufacture of phosphoric acid.

FR 2343082 discloses use of hemi-hydrated calcium sulphate with a depolymerised starch in a coating colour. Hemihydrated calcium sulphate provides a high opacity an absorption capacity as well as whiteness.

GB 465,195 discloses the use of calcium sulphate as an extender in composite titanium pigment, which is used for sizing of paper.

An object of this invention is to minimise or even eliminate the disadvantages existing in the prior art.

An object is also to provide a use of a composition which improves, or at least maintains the inkjet properties of the paper or paperboard, while using inexpensive starting materials.

A further object of this invention is to provide an inkjet recording sheet, which has improved properties for inkjet printing.

These objects are attained with a method and an arrangement having the characteristics presented below in the characterising parts of the independent claims.

Typical use according to the present invention of a composition comprising calcium sulphate dihydrate and starch solution is for treating a surface of an inkjet recording sheet comprising wood or lignocellulosic fibre material for improving inkjet printing properties of the recording sheet.

Typical inkjet recording sheet according to the present invention comprises a substrate comprising wood or lignocellulosic fibre material, surface of which substrate has been treated with a composition comprising calcium sulphate dihydrate and starch solution.

Now it has been found out that use of a composition comprising calcium sulphate dihydrate and starch provides improved properties for inkjet printing when a recording sheet substrate comprising wood and/or cellulose fibres is treated with the said composition, for example when the said composition is applied or coated onto a recording sheet. The recording sheet that is obtained by using the composition has similar or even better substrate properties, which affect the inkjet printability, such as contact angle, Cobb60, HST, ink density black and ink density magenta values, as well as optical properties, such as whiteness and CIELAB values that is achieved with expensive specialty coating pigments and compositions. The present invention provides thus surprisingly good and inexpensive recording sheet alternative for inkjet printing.

In this application the term “ink jet printing” means a process where an image is reproduced on a recording sheet by ejecting droplets of liquid ink at high speed towards and onto the recording sheet. Use of liquid ink in the ink jet printing makes specific demands on the printing substrate. For example, printed ink colour density, ink absorption, ink drying time, Cobb60 values, water fastness and mottling are important properties that are optimised in making of inkjet recording sheets.

The inkjet recording sheet may comprise a substrate comprising wood or lignocellulosic fibre material, which substrate has been coated with or onto which has been applied a composition comprising calcium sulphate dihydrate and starch. Amount of calcium sulphate dihydrate in the composition is 0.1-80 parts, typically 10-80 parts, more typically 10-70 parts, preferably 10-60 parts, more preferably 10-50 parts. According to one embodiment the composition comprises only calcium sulphate dihydrate as pigment material.

Generally, any calcium sulphate dihydrate may be used in the present invention. The particle size D₅₀ of the calcium sulphate dihydrate is usually <50 μm and typically >0.7 μm. According to one embodiment of the invention, calcium sulphate dihydrate, which is used in the composition and for treating, e.g. coating, of the recording sheet substrate, has a particle size D₅₀ which is 0.1 μm≦D₅₀<5.0 μm, more preferably 0.1 μm≦D₅₀<4.0 μm, still more preferably 0.5 μm≦D₅₀<4.0 μm. Preferably, the width of the particle size distribution WPSD of the used calcium sulphate dihydrate is below 2.5, more preferably below 2.0, still more preferably below 1.5. The width of the particle size distribution is given as WPDS=(D₇₅−D₂₅)/D₅₀, and it describes the homogeneity of the particle size distribution. A small WPDS value indicates a narrow particle size distribution, which improves the light scattering and opacity characteristics of the calcium sulphite dihydrate.

The calcium sulphate dihydrate particles used in the present invention may be of any shape. Preferably, the calcium sulphate dihydrate particles have a shape ratio SR, which is at least 1.0, more preferably from 2.0 to 50, still more preferably from 2.0 to 40. The shape ratio SR is given as the ratio between the maximum particle length to the maximum particle thickness. Preferably the used calcium sulphate dihydrate particles have an aspect ratio AS, which is from 1.0 to 10, more preferably from 1.0 to 5.0. The aspect ratio of a particle describe the ratio between the particle length to the particle broadness, i.e. the aspect ratio may be given as the ratio between the longest and shortest dimensions of the particle and is defined more specifically as the ratio of the longest and shortest particle radii that pass through the geometric centre of the particle. The shape and aspect ratios describe the shape and geometry of the particles. It has been found out that the shape of the particles may have an impact to the properties of the final ink receiving layer. It has been surprisingly found out that the whiteness and opacity of the ink receiving coating layer are improved in a manner that is especially suitable for inkjet printing when particles with above shape and aspect ratios are used for treating or coating a recording sheet substrate.

In other words, preferably the calcium sulphate dihydrate particles that are used in the composition and for treating, such as for coating or applying onto, the inkjet recording sheet substrate are small, flat and equal of size. Naturally calcium sulphate dihydrate particles of any shape and any suitable size may be employed.

The calcium sulphate dihydrate, which is used in the composition for treating or coating inkjet recording sheets, may comprise additives, such as dispersants, surfactants or biocides. For example, the amount of dispersing agent used may be from 0.01 to 5.0 weight-%, preferably from 0.05 to 3.0 weight-%, based on the weight of calcium sulphate dihydrate.

According to one embodiment of the invention the calcium sulphate dihydrate is prepared by grinding, crystallization or precipitation. Preferably calcium sulphate dihydrate particles are obtained by crystallization or precipitation. Calcium sulphate dihydrate may also be a mixture of different calcium sulphate dihydrates prepared by different above-mentioned processes. One possible process for preparing calcium sulphate dihydrate suitable to be used in the present invention has been described in publication WO 2008/092991. The calcium sulphate dihydrate that is employed in the present invention may be obtained by a process, where calcium sulphate hemihydrate and/or calcium sulphate anhydrite are contacted with water so that a calcium sulphate dihydrate is obtained as a reaction product, the dry matter content of the reaction mixture being from 34 to 84 weight-%, preferably from 40 and 84 weight-%, more preferably from 50 to 80%, and most preferably from 57 to 80 weight-% in order to obtain a calcium sulphate dihydrate, which comprises crystals that are small, flat and of as equal size as possible. It is possible to obtain crystals of different crystal size and shape factor by adjusting the dry matter content of the process.

During preparation of calcium sulphate dihydrate the temperature of the water in the reaction mixture may be from 0° C. to 100° C., preferably from 0° C. to 80° C., more preferably from 0° C. to 50° C., even more preferably from 0° C. to 40° C., sometimes even from 0° C. to 25° C. Water may also be added to the reaction mixture in the form of water vapour. The initial pH of the reaction mixture is typically between 3.5 and 9.0, preferably between 4.0 and 7.5. pH may be regulated by using addition of an aqueous solution of NaOH and/or H₂SO₄, typically a 10% solution of NaOH and/or H₂SO₄.

Starting material for calcium sulphate dihydrate preparation is typically β-calcium sulphate hemihydrate, which may be prepared by heating gypsum raw material to a temperature of between 140° C. and 300° C., preferably from 150 to 200° C., preferably as fast as possible by using flash calcination, e.g. fluid bed calcination. Also soluble forms of calcium sulphate anhydrite, obtained by calcination of gypsum raw material, may be used as starting material.

Crystal habit modifier may be used in the production process of calcium sulphate dihydrate, but it is not mandatory. The crystal habit modifier may be added to water before it comes into contact with starting material comprising hemihydrate and/or the anhydrite. The crystal habit modifier is preferably a compound having in its molecule one or several carboxylic or sulphonic acid groups, or a salt thereof; or an inorganic acid, oxide, base or salt; or an organic compound, such as an alcohol, an acid or a salt; or a phosphate; or a cationic or non-ionic surfactant. The crystal habit modifier is preferably used in an amount of 0.01 to 5.0%, most preferably 0.02-1.78%, based on the weight of the calcium sulphate hemihydrate and/or calcium sulphate anhydrite. The crystal habit modifier may also be totally omitted.

According to one embodiment of the invention the composition comprises calcium sulphate dihydrate both in dissolved in the starch solution and in solid particulate form. In other words, part of the calcium sulphate in the composition is dissolved in the liquid phase of the composition while part of the calcium sulphate remains in the solid form. Typically the liquid phase of the composition is a saturated solution in regard of calcium sulphate dihydrate. Calcium sulphate dihydrate may be added to the composition in amount which is equal or larger than 2.5 g per 1 litre of starch solution having a dry matter content of 15 weight-%, which amount ensures the formation of saturated calcium sulphate dihydrate solution. Typically the amount of calcium sulphate dihydrate, which is dissolved in the starch solution, is >400 ppm, more typically >500 ppm, preferably >600 ppm, more preferably >700 ppm. The amount of dissolved calcium sulphate is naturally dependent on the total amount of calcium sulphate dihydrate that is used in preparation of the composition, and also on other components of the composition, such as starch and other pigments. It has been observed that when calcium sulphate dihydrate exists both in dissolved and solid form, the properties associated with the porosity are improved in the recording sheet substrate treated or coated with the composition. For example, the air permeability of the recording sheet is clearly reduced, rendering the recording sheet more suitable for inkjet printing.

Starch used in the composition may be any suitable native starch, such as potato, rice, corn, waxy corn, wheat, barley or tapioca starch. Starches having an amylopectin content >80%, preferably >95% are advantageous. Preferably the starch solution comprises non-ionic or cationic starch. Cationic starch comprises cationic groups, such as quaternized ammonium groups. Degree of substitution (DS), indicating the number of cationic groups in the starch on average per glucose unit, is typically 0.01-0.20. Non-ionic starch, i.e. amphoteric starch, may comprise both anionic and cationic groups, but has not an overall charge. Degraded starch is obtained by subjecting the starch to oxidative, thermal, acidic or enzymatic degradation, oxidative degradation being preferred. Hypochlorite, peroxide sulphate, hydrogen peroxide or their mixtures may be used as oxidising agents. Degraded starch has typically an average molecular weight (Mn) 500-10 000, which can be determined by known gel chromatography methods. The intrinsic viscosity is typically 0.05 to 0.12 dl/g, determined, for example, by known viscosimetric methods.

Amount of starch solution in the composition is 5-95 parts, typically 10-95 parts, more typically 20-95 parts, preferably 30-95 parts, more preferably 40-95 parts. Starch solution is a water solution of starch that has been cooked according to methods that are as such well-known for a person skilled in the art.

It is also possible to employ chemically modified starches, such as hydroxyethyl or hydroxypropyl starches and starch derivatives. Also other polysaccharides, e.g. dextrin, may be used to replace starch wholly or partially.

According to one embodiment of the invention the composition comprises also an optical brightener. The use of calcium sulphate dihydrate enhances the effect that is obtained by an optical brightener. This means that it is possible to use smaller amount of optical brightener to obtain the same whiteness, or to use the same amount of brightener to obtain an improved whiteness value. Calcium sulphate dihydrate allows also the use of conventional optical brighteners, whereas some of the prior art inkjet coatings have required the use of expensive specialty brighteners. The optical brightener which is used in the present composition may be a fluorescent whitening agent, such as a tetrasulfonated anionic fluorescent whitening agent, for example tetrasulfonated derivative of 4,4-diamino-stilbene-2,2-disulphonic acid. Also disulfonated or hexasulfonated fluorescent whitening agents may be used. The fluorescent whitening agent may preferably have an UV absorbance maximum around 350 nm and fluorescence maximum around 440 nm. The optical brightener may be used together with a carrier such as polyvinyl alcohol (PVA) or carboxymethyl cellulose (CMC), which improves its adherence to the components of the composition components. The composition may comprise optical brightener in amount of 2-25 parts, typically 2.5-20 parts, preferably 3-15 parts, more preferably 3.5-10 parts.

The composition may comprise also conventional paper coating or surface sizing additives. Possible additives are, for example, preservatives, biocides, dispersing agents, defoaming agents, lubricants and/or hardeners. The amount of other additives is 0-20 parts, typically 0.1-3 parts.

The composition may comprise, in addition to calcium sulphate dihydrate, also other pigment material, such as clay, ground or precipitated calcium carbonate or kaolin. The amount of other pigment material may be in the range 0-80 parts, typically 0-60 parts, preferably 0-40 parts, more preferably 0-20 parts, calculated relative to the amount of the total pigment comprising both calcium sulphate dihydrate and optional other pigment material.

One aspect of the invention comprises a method for improving ink jet printing properties of an inkjet recording sheet comprising wood or lignocellulosic fibre material by treating the recording sheet surface with a composition comprising calcium sulphate dihydrate and starch solution and forming a treatment layer on to the surface. This means that the composition comprising calcium sulphate dihydrate and starch solution may be used for creating a pre-coat layer on the recording sheet surface. In one embodiment of the invention it is possible to coat a coating layer with a different coating composition on top of the treatment layer. Thus the pre-coat or treatment layer comprising calcium sulphate dihydrate and starch may action as a barrier layer between the base paper and the actual printing layer. The actual coating layer that is coated on top of the pre-coat layer is different from the pre-coat layer. For example, it may comprise pigment material other than calcium sulphate dihydrate, such as clay, ground or precipitated calcium carbonate or kaolin.

Another aspect of the invention comprises a method for improving ink jet printing properties of an inkjet recording sheet comprising wood or lignocellulosic fibre material by first coating a recording sheet surface with a conventional paper coating paste comprising pigment particles and binder, and then treating the coated recording sheet surface with a composition comprising calcium sulphate dihydrate and starch solution. In this embodiment the composition comprising calcium sulphate dihydrate and starch solution may be used for creating a post-treatment or finishing layer on the coated recording sheet surface. The pigment employed in the conventional coating composition is typically different from calcium sulphate dihydrate. The conventional coating pigment is usually clay, ground or precipitated calcium carbonate or kaolin.

The recording substrate in sheet form that is used for the inkjet printing and treated or coated with the present composition comprises wood or lignocellulosic fibre material. The substrate may comprise fibres from hardwood trees or softwood trees or a combination of both fibres. The fibres may be obtained by any suitable pulping or refining technique normally employed in paper making, such as thermomechanical pulping (TMP), chemimechanical (CMP), chemithermomechanical pulping (CTMP), groundwood pulping, alkaline sulphate (kraft) pulping, acid sulphite pulping, and semichemical pulping. The substrate may comprise only virgin fibres or recycled fibres or a combination of both. The weight of the recording sheet substrate is 30-800 g/m², typically 30-600 g/m², more typically 50-500 g/m², preferably 60-300 g/m², more preferably 60-120 g/m², even more preferably 70-100 g/m².

According to one embodiment of the present invention composition comprising calcium sulphate dihydrate and starch may be applied to the substrate surface in amount 0.1-7 g/m²/side, preferably 0.5-6 g/m²/side, more preferably 1-5 g/m²/side.

According to one embodiment of the invention the inkjet recording sheet treated or coated with a composition layer, such as coating, comprising calcium sulphate dihydrate has a contact angle (0.05 s)≧50°, ≧70°, preferably ≧80°, more preferably ≧85°, sometimes even ≧90°, measured by using the standard method TAPPI 565 pm-96. An increase in the contact angle indicates an increase in the hydrophobic properties of the measured surface. Most of the inks that are used in the inkjet printing are water based and an increased hydrophobicity of the recording sheet improves the controllability of the ink behaviour in the inkjet printing process.

According to one embodiment of the invention the inkjet recording sheet treated or coated with a composition layer, such as coating, comprising calcium sulphate dihydrate has an air permeability value <600 ml/min, preferably <500 ml/min, more preferably <400 ml/min, sometimes even <300 ml/min or <200 ml/min, measured by using standard method ISO 5636-3:1992. Air permeability values indicate the porosity of the substrate. For recording substrate intended for inkjet printing a small air permeability value is preferred, as it indicates low porosity of the substrate, which prevents the spreading of the ink inside the substrate.

According to an embodiment of the invention the recording sheet treated or coated with a composition layer, such as coating, comprising calcium sulphate dihydrate has an ink absorption value <300 s, typically <200 s, more typically <100 s. The ink absorption value is measured by using a Hercules sizing tester (HST), using standard method TAPPI T530 pm-89.

According to one embodiment of the invention the inkjet recording sheet treated or coated with a composition layer, such as coating, comprising calcium sulphate dihydrate has a CIE Whiteness value ≧110, preferably >120, more preferably >130, measured by using standard method ISO 11475:2004. A high CIE Whiteness value indicates the whiteness of paper. Especially in inkjet printing the whiteness of the recording sheet is of importance, as it allows true reproduction of the printed colours. Now the present invention enables the achievement of similar CIE whiteness values, but by using inexpensive materials.

Water fastness indicates how much the printed ink spreads when contacted with water. It is measured by printing recording sheet sample with HP Business Inkjet 2800 drop-on-demand inkjet printer, equipped with HP11 ink cartridges (HP product code: cyan C4836A, magenta C4837A) and HP11 printheads (HP product code: cyan C4811A, magenta C4812A). Solid cyan and solid magenta test patch, size 50 mm×50 mm, are printed on recording sheet, and the sheet is allowed to set for one minute. The densities of printed patches are measured. After that the sample is placed vertically in water bath, where it is soaked for one minute. After soaking, sample is lifted out, excess water is drained and it is put in a heating chamber until it is totally dry. Temperature of the heating chamber is set to 45° C. and drying time is maximum 15 minutes. Densities of test prints are measured anew after drying and difference between density value measured before soaking and density value after soaking and drying is reported as loss of density, given as percentages of original density value.

It has been observed that the water fastness properties of present recording sheet which has been treated or coated by using calcium sulphate dihydrate are clearly improved when compared to conventional inkjet recording sheets. The inkjet recording sheets according to one embodiment of the invention may have an ink loss value typically <55%, preferably <45%, more preferably <40%.

Ink density black and ink density magenta, measured by using standard methods ISO 5-3:1995, ISO 5-4:1995. Ink density is measured with Techkon Spectropens-densitometer, manufactured by Techkon GmbH. For density and mottling tests the samples are printed with HP Photosmart Pro B9180 drop-on-demand inkjet printer equipped with HP Pigment Ink Cartridges C9412A-C9419A. Samples for print through tests are printed with Kodak Versamark VX5000 continuous inkjet printer. Kodak inks F3001 for cyan, FV3002 for magenta, FV3003 for black and FV3005 yellow are used for printing. The inkjet recording sheet, which has been treated or coated by using calcium sulphate dihydrate, has typically ink density value >1.1, more typically >1.2, preferably >1.3, when printed with Kodak Versamark VX5000 and with inks as described above.

Mottling is a term used to describe irregularities in the amount of ink and gloss of the print, giving rise to a spotted print appearance. Mottling is measured by using an image analyser and a wavelet transform, by using equipment TAPIO® PapEye manufactured by Only Solutions, TAPIO Technologies, Espoo, Finland. First the field to be measured is scanned and the degree of imperfection is determined according to seven stages of resolution: 0.17 mm; 0.34 mm; 0.67 mm; 1.34 mm; 2.54 mm; 5.10 mm; 10.2 mm. The values between the resolution stages are interpolated and the mottling is presented as a sum of these values. The mottling index has a range of 0 to 100, but in practice it lies between 1 and 10. Five replicates of each trial point are carried out. The method is not sensitive to the orientation of the sample. Inkjet recording sheet according to one embodiment of the present invention may have mottling index for light tones <5, preferably <4.5, more preferably <4.3 arbitrary units, the light tone comprising an overprint of cyan 40% screen together with magenta 40% screen. Inkjet recording sheet according to one embodiment of the present invention may have mottling index for dark tones <8, preferably <7, more preferably <6 arbitrary units, the dark tone comprising an overprint of cyan 80% screen together with magenta 80% screen, overprint.

Print-through values describe unwanted appearance of a printed image on the reverse side of the printed recording sheet. Print-through is tested with the following method, which is based on the evaluation of CIELAB (ΔE*) or CIE94 (ΔE94) colour differences between studied and reference areas. The studied area is obtained with aid of a flatbed scanner from the reverse side of the print, and the reference area is obtained from an unprinted area of the paper in question. The values for print-through severity are calculated with a Matlab program maintained by the MathWorks. The colour differences ΔE* or ΔE94 are calculated point wise, and the mean value of colour differences express the intensity of print-through. Inkjet recording sheet according to one embodiment of the present invention may have print-through value <9, preferably <8, more preferably <7, given in arbitrary units. For inkjet recording sheets the value is preferably as low as possible.

According to an embodiment of the invention the inkjet recording sheet treated or coated with a composition layer, such as coating, comprising calcium sulphate dihydrate has a Cobb60 value <70 g/m², preferably <65 g/m², more preferably <60 g/m², measured by using standard method ISO 535:1991. Cobb60 value gives a value for the water absorption to the recording sheet. The smaller the Cobb 60 value is the smaller is the amount of water that is absorbed by the sheet. For inkjet recording sheets a small Cobb60 value is an advantage in order to obtain good printing results with water-soluble inks. The Cobb60 values obtained by using the composition according the present invention may be compared to values that are conventionally obtained by hydrophobic sizing.

In this application the composition of the coating or treating compositions or mixtures are given, as conventional in the art, by giving the total amount of pigments value 100, and calculating the amounts of other components relative to the amount of the total pigment (pph). Proportions of all components are given as active substances.

### EXPERIMENTAL

A composition comprising calcium sulphate dihydrate, as well as a reference composition and a comparative coating composition are prepared using following procedure:

The coating composition is prepared using a low shear mixer. First the starch is pre-cooked, whereby a defined amount of water and starch are added in to a coating container after which the mixture is heated up to near the boiling point. After the starch is pre-cooked then the other components are added under proper shear action, which ensures thorough mixing of the components with each other. The compositions are prepared according the following Table 1. The desired solid content of the coating composition is 15 weight-%.

In compositions Kemira Blankophor® P liq. 01 is used as fluorescent whitening agent and Kemira Polygraphix® is used as surface size agent.

TABLE 1
Components of the different compositions

| | Reference | CaSO₄ | Comparative |
|---|---|---|---|
| Component | Sample | Sample | Sample |
| Starch | 100 | 50 | 50 |
| Ground calcium | — | — | 50 |
| carbonate | | | |
| Calcium sulphate | — | 50 | — |
| dihydrate | | | |
| Fluorescent whitening | 6 | 3 | 3 |
| agent | | | |
| Surface size agent | 1 | 3.5 | 3.5 |
| Parts total | 107 | 106.5 | 106.5 |

Recording sheet substrate is 80 g/m² wood-free base paper including both softwood and hardwood pulps and a filler. Ash content of base paper is roughly 20% and it is not hydrophobic sized. The coating compositions to be tested are applied to the base paper by using meter size press (Metso OptiSizer) at a speed of 500 m/min. By controlling the solid content of the composition, nip pressure and size press running speed, a pickup weight of 3 g/m²/side is achieved for calcium sulphate dihydrate sample and comparative sample, and a pickup weight of 1.5 g/m²/side for reference sample. After the coating the paper sheet is dried and calandered. Calandering is performed as so called soft calandering at temperature 70° C. and with nip load 50 kN/m. The drying temperature for the reference sample is 160° C., and for calcium sulphate dihydrate sample and comparative sample 295° C. With these drying temperatures moist target of 4 weight-% is obtained.

Series of experiments are carried out in order to evaluate the samples for use in ink-jet printing. The properties selected for the evaluation are air permeability, contact angle, Cobb60, whiteness, Cielab values, HST, smearing, ink density black and ink density magenta. The results are given in table 2.

CIELAB values define a colour space in which values L*, a* and b* are plotted at right angles to another to form a three dimensional coordinate system. Equal distance in the space approximately represents equal colour difference. Value L* represents lightness, value a* represents redness/greenness, and value b* represents yellowness/blueness axis. CIELAB colour difference defines the Euclidean distance between the colour coordinates in CIELAB colour space and CIE94 colour difference defines the improvement of CIELAB colour difference model. The CIELAB values are measured by using SCAN-P 72:95 standard.

The quality of the samples is additionally evaluated with water fastness, mottling and print-through tests. The results are presented in tables 3 to 4.

Based on the obtained results, it can be concluded that the loss of ink densities is clearly lower for sample, which is treated with the composition according to the present invention comprising calcium sulphate dihydrate.

Further, it can be concluded that the calcium sulphate dihydrate coated sample shows clearly better print density, print through and mottling values than the reference and comparative samples. Consequently, the calcium sulphate dihydrate coated sample has better inkjet printing qualities than the reference and comparative samples.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

TABLE 2
Measurement results for different recording sheet properties.

| | Reference | | Comparative |
|---|---|---|---|
| Measurement | Sample | CaSO₄ Sample | Sample |
| Air Permeability, ml/min | 374 | 124 | 135 |
| St. dev. | 10 | 17 | 14 |
| CIE Whiteness | 133.21 | 133.86 | 134.17 |
| St. dev. | 0.78 | 1.01 | 1.08 |
| CIE Whiteness, UV | 87.30 | 87.85 | 88.26 |
| excluded | | | |
| St. dev. | 0.69 | 0.11 | 0.17 |
| CIE L* (C/2°) | 92.99 | 93.17 | 93.18 |
| St. dev. | 0.13 | 0.01 | 0.04 |
| CIE a* (C/2°) | 2.86 | 3.01 | 3.07 |
| St. dev. | 0.17 | 0.05 | 0.09 |
| CIE b* (C/2°) | −6.57 | −6.66 | −6.72 |
| St. dev. | 0.22 | 0.12 | 0.16 |
| CIE L* (C/2° -UV) | 92.67 | 92.86 | 92.86 |
| St. dev. | 0.13 | 0.02 | 0.04 |
| CIE a* (C/2° -UV) | 0.75 | 0.87 | 0.94 |
| St. dev. | 0.16 | 0.01 | 0.05 |
| CIE b* (C/2° -UV) | −1.43 | −1.47 | −1.55 |
| St. dev. | 0.22 | 0.03 | 0.06 |
| CIE L* (D65/10°) | 93.63 | 93.81 | 93.82 |
| St. dev. | 0.12 | 0.02 | 0.04 |
| CIE a* (D65/10°) | 2.74 | 2.84 | 2.92 |
| St. dev. | 0.10 | 0.06 | 0.08 |
| CIE b* (D65/10°) | −10.74 | −10.81 | −10.88 |
| St. dev. | 0.22 | 0.22 | 0.24 |
| CIE L* (D65/10° -UV) | 92.78 | 92.97 | 92.98 |
| St. dev. | 0.12 | 0.02 | 0.04 |
| CIE a* (D65/10° -UV) | −0.16 | −0.09 | −0.02 |
| St. dev. | 0.09 | 0.01 | 0.03 |
| CIE b* (D65/10° -UV) | −1.05 | −1.08 | −1.16 |
| St. dev. | 0.21 | 0.03 | 0.06 |
| Cobb 60 | 80.4 | 55.2 | 76.8 |
| HST | 0 | 7.7 | 0.1 |
| Contact Angle 0.05 s | 50.3 | 93.4 | 50.2 |

TABLE 3
Loss of ink density in water fastness test.

| | Density | | Density | | | |
|---|---|---|---|---|---|---|
| | CYAN | | MAGENTA | | Loss, | Loss, |
| Sample | Before | After | Before | After | Cyan | magenta |
| Reference | 1.05 | 0.60 | 0.77 | 0.38 | 43.3% | 50.6% |
| Calcium sulphate | 1.04 | 0.76 | 0.74 | 0.47 | 26.6% | 36.5% |
| Comparative | 1.10 | 0.60 | 0.81 | 0.39 | 45.7% | 51.3% |

TABLE 4
Print density, print through and mottling values for the different samples.

| | Reference | CaSO₄ | Comparative |
|---|---|---|---|
| | Sample | Sample | Sample |
| Print Density | 1.10 | 1.37 | 1.24 |
| Print Through | 13.24 | 6.86 | 8.63 |
| Mottling, light tones* | 4.31 | 4.23 | 4.92 |
| Mottling, dark tones** | 6.02 | 5.89 | 7.33 |

*light tones = (Cyan 40% + magenta 40% overprint)
**dark tones = (Cyan 80% + magenta 80% overprint)

1. Use of a composition comprising calcium sulphate dihydrate and starch solution for treating a surface of an inkjet recording sheet comprising wood or lignocellulosic fibre material for improving its inkjet printing properties.

2. Use according to claim 1, characterised in that the amount of calcium sulphate dihydrate in the composition is 0.1-80 parts.

3. Use according to claim 1 or 2, characterised in that the amount of starch solution in the composition is 5-95 parts.

4. Use according to claim 1, 2 or 3, characterised in that the starch solution comprises non-ionic or cationic starch.

5. Use according to any of preceding claims, characterised in that the composition comprises calcium sulphate dihydrate both in dissolved in the starch solution and in solid form.

6. Use according to claim 5, characterised in that the starch solution comprises >400 ppm calcium sulphate dihydrate in dissolved form.

7. Use according to any of claims 1-6, characterised in that it comprises calcium sulphate dihydrate particles obtained by crystallization or precipitation.

8. An inkjet recording sheet comprising a substrate comprising wood or lignocellulosic fibre material, surface of which substrate has been treated with a composition comprising calcium sulphate dihydrate and starch solution.

9. Inkjet recording sheet according to claim 8, characterised in that it has an air permeability value <600 ml/min.

10. Inkjet recording sheet according to claim 8 or 9, characterised in that it has a contact angle (0.05 s)≧50°.

11. Inkjet recording sheet according to any of claims 8 to 10, characterised in that it has a Cobb60 value, which is <70 g/m².

12. Inkjet recording sheet according to any of claims 8 to 11, characterised in that it has an ink loss value <55%, preferably 45%, more preferably <40%.

13. Inkjet recording sheet according to any of claims 8 to 12, characterised in that it has a CIE whiteness 110.

14. Inkjet recording sheet according to any of claims 8 to 13, characterised in that it has an ink density >1.1.

15. Inkjet recording sheet according to any of claims 8 to 14, characterised in that it has a print-trough value <9.

16. Inkjet recording sheet according to any of claims 8 to 15, characterised in that it has a mottling index for light tones <5.

17. Method for improving ink jet printing properties of an inkjet recording sheet comprising wood or lignocellulosic fibre material by treating the recording sheet surface with a composition comprising calcium sulphate dihydrate and starch solution and forming a treatment layer on to the surface.

18. Method according to claim 17, characterised by coating a coating layer with a different coating composition on top of the treatment layer.
